(19) United States
(12) Patent Application Publication
(10) Pub. No.: US 2018/0161708 A1
(43) Pub. Date: Jun. 14, 2018

(54) FLUID FILTER SYSTEM

(71) Applicant: Caterpillar Inc., Peoria, IL (US)

(72) Inventors: Bryant A. Morris, Dunlap, IL (US); Jeffrey R. Ries, Metamora, IL (US); Brian J. Sutton, Edwards, IL (US)

(73) Assignee: Caterpillar Inc., Peoria, IL (US)

(21) Appl. No.: 15/701,655

(22) Filed: Sep. 12, 2017

Related U.S. Application Data
(60) Provisional application No. 62/433,031, filed on Dec. 12, 2016.

(51) Int. Cl. B01D 35/00

(52) U.S. Cl. CPC B01D 35/005; B01D 36/003

(57) ABSTRACT

A fluid filter system is provided having a canister, a bowl, and a filter positioned inside the canister. The filter includes a sleeve defining a reservoir with filter media surrounding the reservoir. A cover is disposed on a first end of the sleeve and an end cap is disposed on a second end of the sleeve, the end cap having a lid extending across the filter media and sleeve. The bowl includes a sidewall, a floor, and an upper edge. The bowl further includes an upstanding post extending from a floor and the lid further includes a pocket formed along the lid. The pocket defines a cavity disposed outside of the reservoir and includes a threaded portion configured to threadably receive the upstanding post of the bowl. An O-ring seal provides a seal between the bowl and the canister when the upstanding post is threaded to the pocket.

### TECHNICAL FIELD

The present disclosure relates generally to filters, and more particularly, to fluid filter systems.

### BACKGROUND

Engines, including compression-ignition engines, spark-ignition engines, gasoline engines, gaseous fuel-powered engines, and other internal combustion engines, may operate more effectively with fuel from which contaminates have been removed prior to the fuel reaching a combustion chamber of the engine. Fuel contaminates, if not removed, can lead to undesirable operation of the engine and/or may increase the wear rate of engine components, such as, for example, fuel system components.

In typical filters, water is filtered from fuel using a filter element within a canister. Water drains to the lower end of the canister and is collected within a bowl. The bowl is generally threaded to the canister and may have transparent surfaces in order to allow technicians to visualize its contents and determine when the bowl must be serviced. A fluid sensor may also be positioned within the bowl in order to provide a signal for servicing.

When servicing a typical fluid filter, fluid may first be drained from the bowl using a drain extending through the floor of the bowl. The empty bowl may then be removed for cleaning without otherwise spilling fluid. To remove, the bowl is usually unthreaded from the canister and its seal to the canister is unseated. Any remaining fluid and particulate matter in the bowl may then be removed and the bowl can be thoroughly cleaned. Once cleaned, the bowl is rethreaded onto the canister and the bowl seal is reseated against the canister for continued use of the filter system.

Conventional fuel filters with a removable bowl generally employ a threaded connection between a sidewall of the bowl and a lower end of the canister, securing the two together. For example, one such filtration system is described in U.S. Patent Application Publication No. US 2016/0082368 A1 (“the '368 publication”) to Morris, et al., published Mar. 24, 2016. The '368 publication discloses a fuel filter with a filter element supported within a canister and a bowl affixed to the canister. The lower end of the canister includes a threaded portion and the sidewall of the bowl includes complementary threads to secure the two together. A seal is positioned adjacent to the threads to seal the bowl to the canister. Therefore the canister supports the bowl. In addition, an embodiment in the '368 publication includes a centrally-located drain extending through the bowl that connects the drain to the lower end cap of the filter.

Although the fuel filter of the '368 publication provides a fuel filter system with a bowl and canister, the bowl is supported by the canister. This may limit the available methods for servicing the bowl and for removing the filter element from the canister. Moreover, a centrally-located drain limits the positioning of the fluid sensor in the bowl. The disclosed system is directed to overcoming the one or more of the problems set forth above and other problems in the prior art.

### SUMMARY OF THE INVENTION

In one aspect, the present disclosure is directed to a fluid filter system including a canister, a bowl, and a filter positioned inside the canister. The filter includes a sleeve defining a reservoir with filter media surrounding the reservoir. A cover is attached to a first end of the sleeve and an end cap is disposed on a second end of the sleeve, the end cap having a lid extending across the filter media and sleeve. The bowl includes a sidewall, a floor, an upper edge, and an upstanding post extending from a floor of a bowl. A pocket is formed along the lid of the end cap, the pocket including a sidewall with an exterior surface and an interior surface. At least one of the exterior surface or interior surface of the sidewall includes a threaded portion, and the pocket defines a cavity disposed outside of the reservoir. The threaded portion of the pocket is configured to threadably receive the upstanding post of the bowl, and an O-ring seal is configured to engage the sidewall of the bowl and provide a seal between the bowl and a lower end of the canister when the upstanding post of the bowl is threadably received by the threaded portion of the pocket.

In another aspect, the present disclosure is directed to a filter including a sleeve disposed between a cover and an end cap, defining a reservoir. Filter media surrounds the sleeve and allows a first fluid to pass into the reservoir while blocking the passage of impurities and a second fluid. The cover includes an opening to outside of the filter, while the end cap includes a lid that extends across the sleeve and the filter media, and a pocket extending from the lid. The pocket includes a sidewall with an exterior surface and an interior surface, where at least one of the exterior surface or interior surface of the pocket is a threaded portion. The pocket defines a cavity disposed outside of the reservoir and the threaded portion is configured to threadably receive an upstanding post from a floor of a bowl that is configured to receive the impurities and the second fluid. The sidewall of the pocket has at least one vent aperture.

In yet another aspect, the present disclosure is directed to a filter bowl including a sidewall, a floor, an upper edge, and an upstanding post extending from a floor of the filter bowl. The upstanding post has a hollow interior and an outer wall including an exterior surface and an interior surface. At least one of the exterior surface or the interior surface of the wall has a threaded portion, where the upstanding post is configured to be threadably received by a pocket formed along an end cap of an associated filter. The sidewall is a generally smooth surface configured to receive an O-ring seal adjacent to the upper edge thereof.

### BRIEF DESCRIPTION OF THE DRAWINGS

FIG. 1 is a side cross-sectional view of an exemplary fluid filter system;

FIG. 2 is a side cross-sectional view of the canister and filter of the exemplary fluid filter system of FIG. 1.

FIG. 3 is a side cross-sectional view of the bowl of the exemplary fluid filter system of FIG. 1.

FIG. 4 is a perspective cross-sectional view of the exemplary fluid filter system of FIG. 1;

FIG. 5 is a side cross-sectional view of another exemplary embodiment of the fluid filter system; and

FIG. 6 is a side cross-sectional view of yet another exemplary embodiment of the fluid filter system.

### DETAILED DESCRIPTION

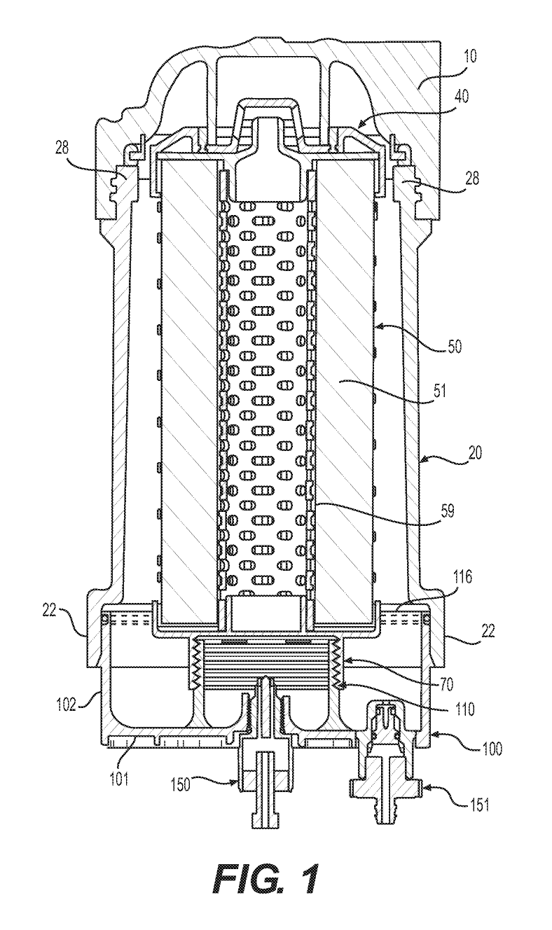

FIG. 1 illustrates an embodiment of the fluid filter system of the present disclosure. As will be discussed more thoroughly below, the fluid filter system includes a canister 20, a filter 50, and a bowl 100. The canister 20 surrounds the filter 50 and includes an upper end 28 and a lower end 22. The upper end 28 of the canister 20 secures to a base 10, such as an engine block or another assembly. The filter 50 within the canister 20 includes a filter media 51 extending between a cover 40 and an end cap 80.

The general construction and use of a fluid filter system will be discussed in brief. A fluid to be filtered is received by the fluid filter system from the base 10 and through the cover 40. The fluid enters an interior 26 of the canister 20 along an exterior of the filter media 51. Pressure drives the fluid through the filter media 51 and into a reservoir 52. The filter media 51 permits a first fluid to pass through and blocks passage of impurities and a second fluid. The first fluid is drawn into the reservoir 52 of the filter 50 and is then drawn out of the filter 50 through the cover 40. The second fluid flows downward between the canister 20 and the filter media 51 and is collected within the bowl 100.

The fluid filter system of the present disclosure may be used to filter diesel, gasoline, or other liquid fuels for a machine (e.g. an engine, etc.) and to separate water from such fuels. However, the fluid filter system with the features described herein may also be adapted to serve different purposes and suit other applications.

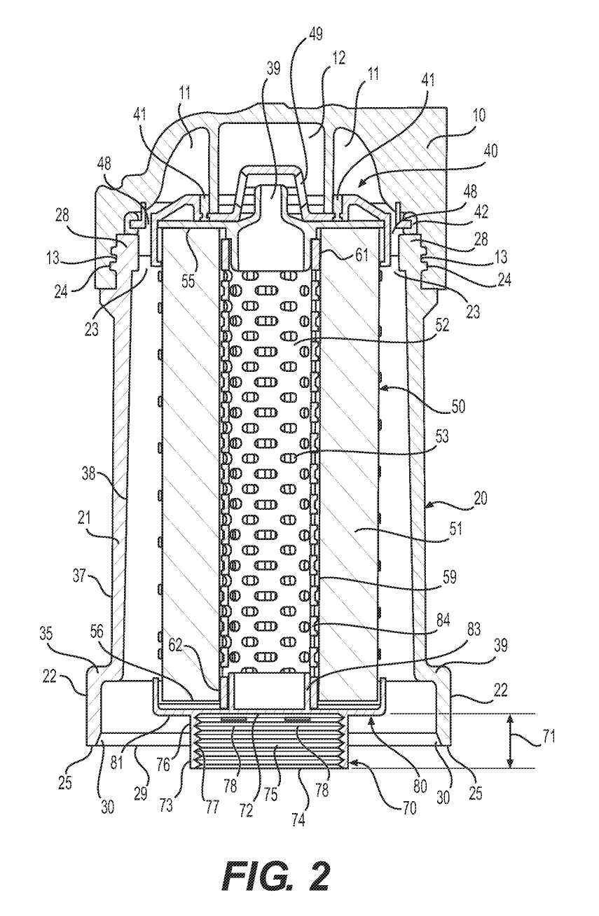

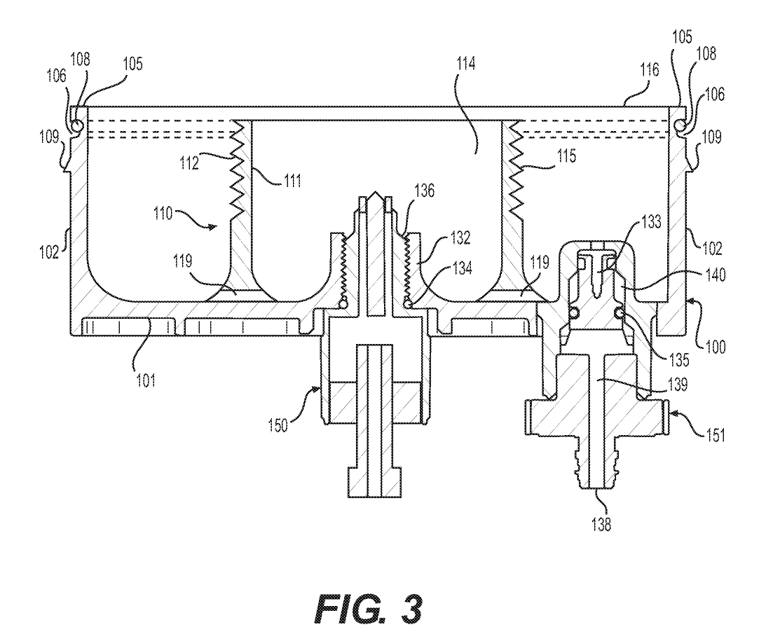

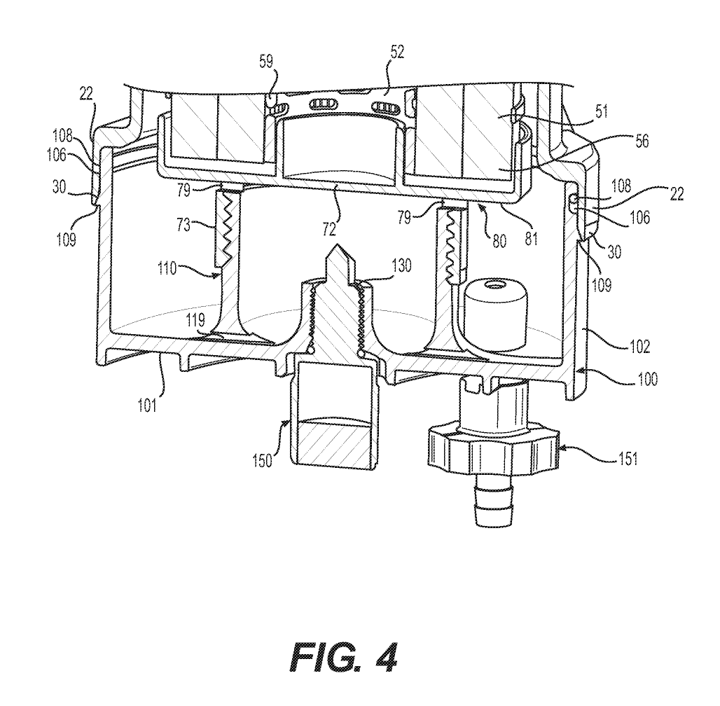

FIGS. 1-4 illustrate cross-sectional views of an embodiment of the fluid filter system. The filter system includes the canister 20, the filter 50, and the bowl 100. The canister 20 includes a sidewall 21, an upper end 28, and a lower end 22. The upper end 28 is configured to secure to the base 10 using threads 24. The threads 24 may be positioned along an exterior surface 37 or an interior surface 38 of the sidewall 21. The threads 24 of the canister 20 are configured to engage threads 13 along the base 10. The threads 24, 13 of the canister 20 and the base 10 are but one example of an engagement structure that may be used between the base 10 and canister 20 to form a releasable engagement. Other engagement structures may be used.

In an embodiment, the canister 20 may form a cylindrical shape around the filter 50 forming a rounded cross section. The upper end 28 has an upper opening 23 distal from the bowl 100 and adjacent to the threads 24. The lower end 22 of the canister 20 has an lower opening 29 that is proximal to the bowl 100. The cover 40 is disposed on a first end 61 of the sleeve 59 and an end cap 80 is disposed on a second end 62 of the sleeve 59. When a filter 50 is positioned in the canister 20, the cover 40 is positioned along the upper end 28 of the canister 20 and allows for the outflow and inflow of fluid into the fluid filter system.

The cover 40 includes a cover outlet 49, a cover inlet 48, an outer seal 42, and an inner seal 41. Filtered fuel exits the filter 50 from the sleeve 59, through the cover 40, and into an outlet channel 12 in the base 10 to be reused. A sleeve outlet 39 along an upper end of the sleeve 59 provides a pathway to the cover outlet 49 and the outlet channel 12 of the base 10. The cover 40 therefore defines a fluid channel out of filter 50 for filtered fluid.

Along the cover are the inner seal 41 and outer seal 42, which may define and/or seal the fluid channels in and out of the filter 50. The inner seal 41 and outer seal 42 may be annular, where the inner seal 41 seals the outlet channel 12 from an inlet channel 11 in the base 10 when the cover 40 is secured against the base 10. The outer seal 42, larger in diameter than inner seal 41, may extend around an outer perimeter of the cover 40 and provide a seal between canister 20 and base 10. The outer seal 42 thus prevents fluid in inlet channel 11 from leaking out of the joint between canister 20 and base 10, while the inner seal 41 prevents leaking between the inlet channel 11 and the outlet channel 12.

The inner seal 41 and outer seal 42 may be integrally formed with cover 40 or attached with adhesives or other methods. The seals 41, 42 are seated against the base 10 when the cover 40 is secured against the base 10 using the threads 24, 13. When the canister 20 is threaded to the base 10, the upper end 28 of the canister 20 is drawn against the base 10 and the seals 42, 41 are seated between the cover 40 and the base 10. The upper end 28 of the canister 20 therefore bears against the outer seal 42, compressing the cover 40 and seals 41, 42 against the base 10.

In one embodiment, the filter 50 of the present disclosure is one suited for separating water from fuel. However, the filter 50 of the fluid filter system may take different forms depending on the particular application. While the embodiment discussed below describes separation of water from fuel, other embodiments of the filter may be used having broader purposes; namely, to separate a first fluid from a second fluid. The filter media 51 of the filter 50 surrounds the sleeve 59 defining a reservoir 52 within the sleeve 59. The reservoir 52 may be centralized within the filter media 51. The filter media 51 may also be generally annular in shape and may circumferentially surround the reservoir 52. The sleeve 59 defines a longitudinal sleeve axis and may be generally cylindrical in shape. Moreover, perforations 53 through the sleeve 59 may allow fluid to pass from the filter media 51 into the reservoir 52. The filter media 51 is disposed between the cover 40 along its upper end 55 and the end cap 80 along its lower end 56.

The lower end 56 of the filter 50 is disposed proximal to the lower end 22 of the canister 20 and the upper end 55 of the filter 50 is disposed proximal to the upper end 28 of the canister 20. The cover 40 is disposed on the upper end 55 of the filter 50 and is secured against the base 10 by the canister 20. The sleeve outlet 39 allows the passage of fluid through the cover outlet 49 to the outlet channel 12. In contrast, the end cap 80 along the lower end 56 of the filter 50 prevents fluids in the bowl 100 from flowing into the sleeve 59 and into the reservoir 52. Thus, the upper end 55 of the filter 50 is open and the lower end 56 is closed. The end cap 80 may extend continuously across the lower end 56 of the filter media 51 and the sleeve 59 to block fluid. Both the cover 40 and end cap 80 may be joined to opposite ends of the sleeve 59 via welding, adhesives, or other methods known to the art. Alternatively, several or all of sleeve 59, cover 40, and end cap 80 may be separate, unitary components.

To filter fluid, an unfiltered fluid comprising a first fluid and a second fluid to be filtered enters the fluid filter system through the inlet channel 11 of the base 10 and flows through the upper opening 23 of the canister 20. The unfiltered fluid then enters the interior 26 of the canister 20 between filter media 51 and the sidewall 21. The filter media 51 is of a type known in the art to separate both impurities and a first fluid from a second fluid. In one embodiment, the first fluid is fuel and the second fluid is water. As noted previously, in other embodiments, other combination of fluids may be separated. Fuel passes into and through filter media 51 from the interior 26 of the canister 20 and then flows into the reservoir 52 of the sleeve 59 through the perforations 53 in the sleeve 59. Water does not pass through the filter media 51 and, because water is typically heavier than fuel, flows downward through the lower opening 29 and into the bowl 100 where it accumulates for subsequent removal. Filtered fuel, after passing through the filter media 51, exits the reservoir 52 of the sleeve 59 through cover 40 via the cover outlet 49 and into the outlet channel 12 of the base 10.

The end cap 80 is disposed along a lower end 56 of the filter 50 and functions as a barrier to prevent unfiltered fuel and/or water from entering the reservoir 52. This prevents unfiltered fluid from bypassing the filter media 51 and entering the outlet channel 12 for reuse. The end cap 80 includes a lid 81 extending across the sleeve 59 and the filter media 51 at the lower end 56 of the filter media 51. The lid 81 encloses the lower end 56 of the filter media 51 and includes a pocket 70. The pocket 70 extends from the lid 81. In some embodiments, the pocket 70 extends downward toward the bowl 100. In others embodiments, the pocket 70 extends upward into the sleeve 59. The pocket 70, extending upwards, downwards, or in both directions, has a cavity 75 that is separated from the reservoir 52 of the sleeve 59. This prevents water and filtered fluid from entering the reservoir 52 from the bowl 100 through the pocket 70. The pocket 70 is configured to threadably secure to an upstanding post 110 extending from a floor 101 of the bowl 100, securing the bowl 100 to the lid 81 and thus to the lower end 56 of the filter 50.

In one embodiment, and as illustrated in FIGS. 1-4, the pocket 70 extends downward from the lid 81. The pocket 70 includes a sidewall 73 with an exterior surface 76 and an interior surface 77. At least one of the exterior surface 76 and interior surface 77 includes threads 79 forming a threaded portion. The sidewall 73 may form an annular wall defining the cavity 75, which may be configured to receive the upstanding post 110 of the bowl 100. Alternatively, the sidewall 73 of the pocket 70 may be configured to be received within an interior 114 of the upstanding post 110. Threads 115 on an interior surface 111 or an exterior surface 112 of the upstanding post 110 are complementary to the threads 79 of the pocket 70. The upstanding post 110 therefore is threaded to the pocket 70 to secure the two together, either by receiving the upstanding post 110 within the cavity 75 or by the upstanding post 110 securing over the exterior surface 76 of the pocket 70. FIGS. 1-4 illustrate an embodiment with a threaded portion along the interior surface 77 of the pocket 70, and one in which the upstanding post 110 is configured to be received within the pocket 70. In either embodiment, the connection between the upstanding post 110 and pocket 70 is used to support the bowl 100 proximal to the lower end 22 of the canister 20.

The cavity 75 of the pocket 70 is separated from and outside of the reservoir 52. The cavity 75 has a top 72 that is enclosed and defined by the lid 81. The pocket 70 may reside completely outside of the sleeve 59 or may reside partially therein. In either embodiment, the cavity 75 of the pocket 70 is separated from the reservoir 52 of the sleeve 59 to prevent unfiltered fluid from entering and contaminating filtered fluid in the reservoir 52.

In one embodiment, the lid 81 may include a retaining wall 83 extending into the sleeve 59. The retaining wall 83 may be cylindrical with an upper edge 84 that may be curved or sloped. The retaining wall 83 may be aligned with a longitudinal axis of the sleeve 59 and a longitudinal axis of the pocket 70. Alternatively, as will be discussed below, the sidewall 73 of the pocket 70 may extend into the sleeve 59.

The pocket 70 further includes a mouth 74 and a height 71 extending from the lid 81. The mouth 74 is open, while the height 71 is configured to be less than a distance between the lid 81 and the floor 101 of the bowl 100 when the bowl 100 is seated against the lower end 22 of the canister 20 and the cover 40 of the filter 50 is secured to the base 10 by the canister 20. This prevents interferences between the bowl 100 and the pocket 70, allowing the upstanding post 110 to engage the threads 79 of the pocket 70 as the bowl 100 is seated against the canister 20.

In addition, the pocket 70 has vent apertures 78 through its sidewall 73. The vent apertures 78 permit air to pass in and out of the cavity 75 of the pocket 70. The vent apertures 78 may be positioned proximal to the lid 81 so they are not covered by the upstanding post 110. Alternatively, corresponding vent apertures 78 may also be provided through the upstanding post 110 that align with the vent apertures 78 through the pocket 70. The vent apertures 78 of the pocket are configured to prevent air bubbles from being trapped in the cavity 75. In addition, fluid passages 119 through the upstanding post 110 allow fluid in the bowl 100 to move in and out of the interior 114 of the upstanding post 110 to ensure the fluid level remains uniform across the floor 101 of the bowl 100, both inside and outside of the upstanding post 110.

The threaded connection between the upstanding post 110 and the pocket 70 operates to secure the bowl 100 to the filter 50 and the lower end 22 of the canister 20. An O-ring seal 108 is used to secure and seal a sidewall 102 of the bowl 100 to the lower end 22 of the canister 20. As the upstanding post 110 of the bowl 100 secures to the pocket 70, an upper edge 105 of the bowl 100 is drawn towards the lower end 22 of the canister 20 and the O-ring seal 108 of the bowl 100 seals the canister 20 to the bowl 100. The lower end 22 of the canister 20 includes a lower opening 29, where the sidewall 102 of the bowl 100 may be configured to be received within the lower opening 29 or the sidewall 21 of the canister 20 may be received within the interior of the bowl 100. In one embodiment, the lower end 22 of the canister 20 includes a shoulder 35, increasing the diameter of the canister 20 along its lower end 22 to receive the bowl 100 within the lower opening 29.

The O-ring seal 108 is configured to engage the sidewall 102 of the bowl 100 and the sidewall 21 of the canister 20 to provide a seal between the two when the upstanding post 110 of the bowl 100 is threadably received by the threaded portion of the pocket 70. The O-ring seal 108 may be disposed within a groove 106 defined along an outer surface of the sidewall 102, or within a groove 106 defined along an inner surface of the sidewall 102. FIGS. 1-6 show the former embodiment, where the bowl 100 is received within the lower opening 29 of the canister 20 and the O-ring seal 108 is disposed within a groove 106 along an outer surface of the sidewall 102.

Once the bowl 100 is threaded to the pocket 70, the O-ring seal 108 seals the bowl 100 to the canister 20. A rib 109 extending around the sidewall 102 of the bowl 100 may also engage the lower edge 25 of the canister 20. In some embodiments, the rib 109 may comprise a ramped surface extending from the sidewall 102, and in other embodiments the rib 109 may comprise a rectangular protrusion extending from the sidewall 102. The rib 109 engages a notch 30 along the lower edge 25 of the canister 20. The rib 109 and notch 30 provide a stop or an indication when installing the bowl 100 that the upstanding post 110 has fully engaged the pocket 70 and the bowl 100 is properly secured against the canister 20. The notch 30 also allows for a larger lower opening 29 and facilitates inserting the bowl 100 into the lower opening 29.

Once the upstanding post 110 is threaded to the pocket 70, the bowl 100 is secured to the canister 20 and the O-ring seal 108 is seated between the two. The bowl 100 has an upper opening 116 such that impurities and one or more second fluids separated from the first fluid in the canister 20 can drain downwards and be received in the bowl 100. The bowl 100 collects these impurities and fluids, and is periodically drained and/or removed from the canister 20 to be cleaned. The bowl 100 may be made of a transparent or translucent material to facilitate inspection of the bowl 100 by visualizing its contents without requiring removal.

In one embodiment, fluid can be removed from the bowl 100 without removing the bowl 100 from the canister 20 or removing the canister 20 from the base 10. A drain 151 may be provided along the floor 101 of the bowl 100 for this purpose. The drain 151 penetrates the bowl 100 through a bore 140 in the floor 101. An O-ring seal 135 seals the bore 140 around the drain 151. Extending through the drain 151 is a drain channel 139 for removing fluid from inside the bowl 100 and canister 20. The drain 151 may be elongated and may include a relief end 133 and an outlet end 138 connected to one another by the drain channel 139. The relief end 133 is positioned inside the bowl 100 and is configured to draw fluid from therein when draining the bowl 100. The outlet end 138 is positioned outside of bowl 100. In some embodiments, the drain 151 may be moved between a closed position and an open position. In the closed position, fluid is not able to flow through drain channel 139 and out of the bowl 100. In the open position, fluid is able to flow through drain channel 139 and out of the bowl 100 through outlet end 138. The position of the drain 151 may be controlled by a vacuum device affixed to the outlet end 138. However, the specific design of the drain 151 may be configured to suit many different applications and methods of draining. The illustrated embodiment provides only one exemplary configuration.

In addition to the drain 151, the bowl 100 also may support a fluid sensor 150 along the floor 101 of the bowl 100. The fluid sensor 150 is a sensor that monitors a fluid level in the bowl and may trigger or be activated when the fluid level reaches a threshold amount. Because the base 10 to which the fluid filter system attaches may be angled and not level (i.e. a vehicle may be on a gradient or on a hill), in one embodiment the fluid sensor 150 may be located along the central axis of the bowl 100 to ensure an average fluid level across the bowl 100 is measured. Therefore, the fluid sensor 150 may be positioned through a bore 130 in the floor 101 of the bowl 100 and disposed within the interior 114 of the upstanding post 110.

The interior 114 of the upstanding post 110 and the diameter of its sidewall are therefore sized to receive the fluid sensor 150 therein. This allows the fluid sensor 150 to be centrally located in the bowl 100 for accurate average measurements. Moreover, the fluid passages 119 in the upstanding post 110 ensure the fluid level will be uniform across the interior of the bowl 100. In one embodiment, the fluid sensor 150 is secured through the bore 130 and is threadably affixed to the bore 130. An O-ring seal 134 seals the fluid sensor 150 to the bore 130, while an upstanding wall 132 around the bore 130 may provide sufficient threads to secure the fluid sensor to the bowl 100.

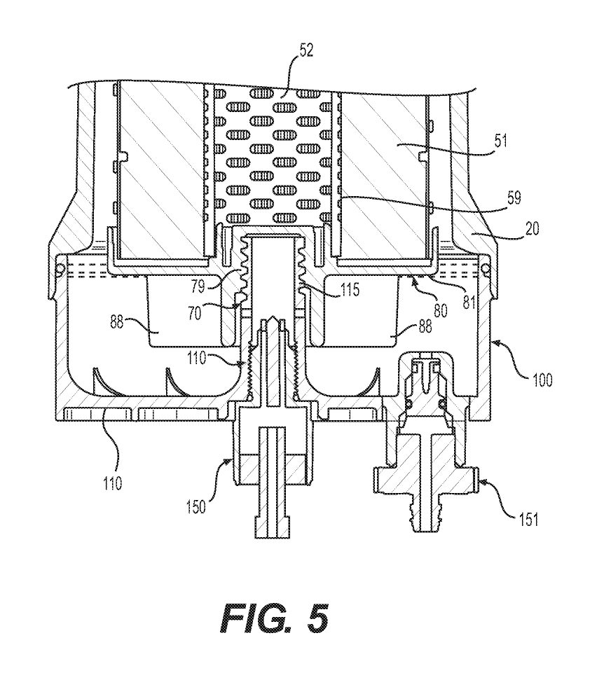

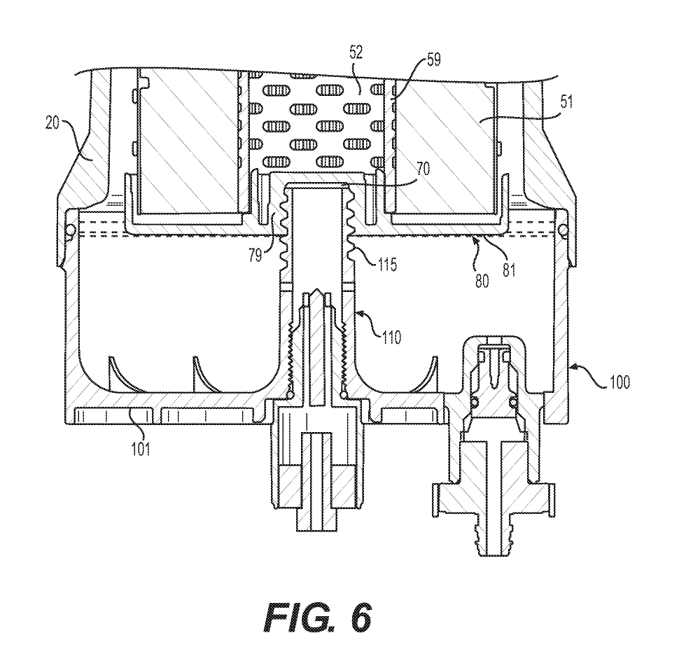

As shown in FIGS. 5 and 6, the pocket 70 may extend into the sleeve 59 in some embodiments. In particular, the pocket 70 may extend into the sleeve 59 such that the upstanding post 110 is disposed within the sleeve 59 when the bowl 100 is fully seated against the canister 20. In this embodiment, the threads 79 of the pocket 70 are along the interior surface and engage threads 115 along the exterior surface of the upstanding post 110. In some embodiments, the sidewall 73 of the pocket 70 may also extend downward from the lid 81. In this manner, the pocket 70 is partially disposed within the sleeve 59 and below the lid 81. However, in either embodiment, the top 72 of the pocket 70 separates the reservoir 52 of the sleeve 59 from the cavity 75 of the pocket 70.

In addition to the pocket 70 extending into the interior of the bowl 100, the cover 40 may additionally include a plurality of fins 88. The fins 88 may be any shape that extends outward from the end cap 80 and the pocket 70. In the disclosed embodiment, the fins 88 extend perpendicular to the pocket 70 and may have a generally rectangular shape with an outer edge that may be chamfered. The fins 88 are not limited to this shape. In other embodiments, the fins 88 may have a beveled, curved or rounded outer edge. The fins 88 may be joined to the pocket 70, where the quantity of fins 88 and the spacing around the pocket 70 may vary. In addition, the fins 88 may have a longitudinal height that may be equal to or less than the height 71 of the pocket 70. The height 71 of the pocket 70 may be between about 0.7 to about 1.0 times the height 71 of the bowl 100 in order to keep the filter media 51 substantially above and out of the fluid that accumulates in the bowl 100 during use.

### INDUSTRIAL APPLICABILITY

The disclosed fluid filter system may be applicable to any machine that includes a base 10 and a fluid to be filtered. By supporting the bowl 100 from the end cap 80 and not otherwise threading the bowl 100 to the canister 20, several benefits for servicing the bowl 100 and the filter 50 are provided. Servicing of fluid filter system will now be explained.

During operation of fluid filter system, filtered fluid collects within the bowl 100. The bowl 100 is inspected using its transparent sidewalls or a technician is notified when the bowl 100 is full by the fluid sensor 150. To service the bowl 100, its contents can first be drained using the drain 151 in the floor 101 of the bowl 100. Then, the bowl 100 can be unthreaded from the end cap 80 of the filter 50 and the O-ring seal 108 of the bowl 100 can be unseated from the canister 20. By employing a smooth surface along the upper edge 105 of the bowl 100, its sidewall 102 only engages the canister 20 by the friction of the O-ring seal 108. This allows the bowl 100 to be easily unthreaded from the end cap 80 and removed from the fluid filter system. The canister 20 continues to secure the filter 50 against the base 10, and the filter does not rotate as the bowl 100 is unthreaded. Similarly, the singular threaded connection between the bowl 100 and fluid filter system prevents binding that would otherwise occur from threads along both the sidewall 102 and upstanding post 110 of the bowl 100. The bowl 100 is unthreaded from the end cap 80 as the sidewall 102 of the bowl 100 is pulled from the lower end 22 of the canister 20. The filter 50 remains against the base 10 as the bowl 100 is drained, unthreaded, and cleaned.

When servicing the filter 50, the canister 20 and the bowl 100 can remain attached to one another after being removed from the base 10. Using the friction of the O-ring seal 108 between the canister 20 and bowl 100, the two remain affixed as the fluid filter system is removed from the base 10 and the filter 50 is removed from the canister 20. The canister 20 is first unthreaded from the base 10 while the bowl 100 remains affixed to the canister 20 and end cap 80 of the filter 50. Once the fluid filter system is separated from the base 10, the filter 50 is accessible from the upper opening 23 of the canister 20. The filter 50 is unthreaded from the bowl 100 and removed through the upper opening 23 of the canister 20. The filter media 51 or the entire filter 50 may be replaced. The filter 50 can then be placed back in the canister 20 and threaded to the bowl 100. The canister 20 is rethreaded to the base 10, bearing the seals 41, 42 against the base 10. During this process, the filter 50 may draw the bowl 100 towards the canister 20 and vice versa. Additionally, the position of the lower end 56 of the filter 50 is controlled within the fluid filter system by its connection to the bowl 100.

The end cap 80 of the filter 50 is therefore used to support the bowl 100. The filter 50 draws the bowl 100 towards the lower end 22 of the canister 20 when threading the end cap 80 to the upstanding post 110. The bowl 100 is drawn toward the canister 20 to properly position the bowl 100 proximal to the lower end 22 of the canister 20. During this installation process, the bowl 100 does not spin during engagement of the end cap 80 to the bowl 100. Rather, the filter 50 spins relative to the canister 20 and the bowl 100.

In addition to improving removal during servicing, the bowl 100 of the present disclosure also allows the fluid sensor 150 to be placed along the longitudinal axis of the bowl 100. The interior 114 of the upstanding post 110 provides clearance for the fluid sensor 150, while the drain 151 can be located outside of the upstanding post 110. This allows the fluid sensor 150 to obtain accurate average fluid level measurements, regardless of the angle or inclination of the base 10.

It will be apparent to those skilled in the art that various modifications and variations can be made to the fluid filter system. Other embodiments will be apparent to those skilled in the art from consideration of the specification and practice of the disclosed fluid filter system. It is intended that the specification and examples be considered as exemplary only, with a true scope being indicated by the following claims and their equivalents.

What is claimed is:

1. A fluid filter system, comprising:
a canister and a bowl;
a filter positioned inside the canister, the filter including a sleeve defining a reservoir with filter media surrounding the reservoir;
a cover disposed on a first end of the sleeve and an end cap disposed on a second end of the sleeve, the end cap having a lid extending across the filter media and sleeve;
the bowl including:
a sidewall, a floor, and an upper edge; and
an upstanding post extending from a floor of a bowl;
a pocket formed along the lid, the pocket including a sidewall with an exterior surface and an interior surface;
at least one of the exterior surface and interior surface of the sidewall including a threaded portion;
the pocket defining a cavity disposed outside of the reservoir and the threaded portion being configured to threadably receive the upstanding post of the bowl; and
a seal configured to engage the sidewall of the bowl and provide a seal between the bowl and a lower end of the canister when the upstanding post of the bowl is threadably received by the threaded portion of the pocket.

2. The fluid filter system of claim 1, wherein the pocket extends from the lid into the bowl.

3. The fluid filter system of claim 1, wherein the sidewall of the pocket has at least one vent aperture.

4. The fluid filter system of claim 1, wherein the seal is an O-ring seal that is configured to be disposed within a groove defined along an outer surface of the sidewall.

5. The fluid filter system of claim 1, wherein the seal is configured to be disposed within a groove defined along an inner surface of the sidewall.

6. The fluid filter system of claim 1, wherein the cavity of the pocket extends into the sleeve.

7. The fluid filter system of claim 1, wherein the cavity of the pocket is outside of the sleeve.

8. The fluid filter system of claim 1, wherein:
the upstanding post of the bowl further includes a hollow interior;
a sensor supported within the hollow interior of the upstanding post and within a bore defined through the floor of the bowl and coaxial with the upstanding post; and
wherein the upstanding post includes at least one vent aperture.

9. The fluid filter system of claim 1, further including a drain supported within a bore through the floor of the bowl.

10. A filter, comprising:
a sleeve defining a reservoir, the sleeve being disposed between a cover and an end cap;
filter media surrounding the sleeve and allowing a first fluid to pass into the reservoir but blocking the passage of impurities and a second fluid;
the cover including an opening to outside of the filter; and
the end cap including:
a lid that extends across the sleeve and the filter media;
a pocket extending from the lid, the pocket including a sidewall with an exterior surface and an interior surface;
at least one of the exterior surface and interior surface of the pocket having a threaded portion;
the pocket defining a cavity disposed outside of the reservoir, and the threaded portion being configured to threadably receive an upstanding post from a floor of a bowl configured to receive the impurities and the second fluid;
the sidewall of the pocket having at least one vent aperture.

11. The filter of claim 10, further including a plurality of outer fins disposed on the exterior surface of the pocket.

12. The filter of claim 10, wherein at least one of the plurality of outer fins is substantially perpendicular with the pocket.

13. The filter of claim 10, wherein the cavity of the pocket extends into the sleeve.

14. The filter of claim 10, wherein the cavity of the pocket is outside of the sleeve.

15. The filter of claim 10, wherein the end cap is configured to support the weight of the bowl when the bowl is filled with the impurities and the second fluid and secure the bowl to a filter canister configured to contain the filter without additional support.

16. A filter bowl, comprising:
a sidewall, a floor, and an upper edge;
an upstanding post extending from a floor of the filter bowl;
the upstanding post having a hollow interior, and an outer wall including an exterior surface and an interior surface, wherein at least one of the exterior surface and the interior surface of the wall having a threaded portion;
the upstanding post being configured to be threadably received by a pocket formed along an end cap of an associated filter; and
the sidewall of the bowl having an outer surface and an inner surface, each being a generally smooth surface where at least one of the outer surface and the inner surface is configured to receive a seal adjacent to the upper edge thereof.

17. The filter bowl of claim 16, wherein the seal is disposed within a groove defined along the outer surface of the sidewall.

18. The filter bowl of claim 16, wherein the seal is disposed within a groove defined along the inner surface of the sidewall.

19. The filter bowl of claim 16, further including:
a sensor supported within the hollow interior of the upstanding post and within a bore defined through the floor of the bowl and coaxial with the upstanding post; and
wherein the upstanding post has at least one vent aperture.

20. The filter bowl of claim 16, further including a drain supported within a bore defined through the floor of the bowl.
